(19) United States
(12) Patent Application Publication
(10) Pub. No.: US 2012/0068974 A1
(43) Pub. Date: Mar. 22, 2012

(54) Optical Position Detection Apparatus

(76) Inventor: Yasuji Ogawa, Ibaraki (JP)

(21) Appl. No.: 13/321,485

(22) PCT Filed: May 21, 2010
(86) PCT No.: PCT/JP2010/003455

§ 371 Date: Nov. 18, 2011

Related U.S. Application Data
(60) Provisional application No. 61/181,503, filed on May 27, 2009.

(30) Foreign Application Priority Data
May 26, 2009 (JP) 2009-128049

(51) Int. Cl. G06F 3/042

(52) U.S. Cl. 345/175

(57) ABSTRACT

An optical position detection apparatus includes a retroreflective member 10 and a detection unit 20. The retroreflective member 10 is disposed so as to cover two predetermined sides of the perimeter of the detection area 1. The detection unit 20 is disposed adjacent to a corner opposite to the two predetermined sides and detects a pointing position of the pointer by using reflection light reflected from the retroreflective member. The detection unit 20 includes two detection sections 21 each having a light source section that emits light traveling along the surface direction of the detection area and a camera section that images reflection light emitted from the light source section and reflected by the retroreflective member. The light source section has an irradiation angle wide enough to irradiate the two predetermined sides with light, and the camera section is disposed close to the light source section and has a viewing angle wide enough to image the two predetermined sides.

### TECHNICAL FIELD

The present invention relates to an optical position detection apparatus, and more particularly to an optical position detection apparatus that uses an image sensor to optically detect a position on a detection area pointed by a pointer.

### BACKGROUND ART

In recent years, there have been developed various optical position detection apparatuses and digitizers that use an image sensor. For example, Patent Document 1 filed by the present inventor discloses an optical digitizer having an image sensor which is arranged around a detection area so as to image a pointer, an imaging lens for imaging the pointer image on the image sensor, and a curved mirror for expanding the viewing angle of the image sensor. In this technique, curved mirrors are used in order to prevent a disadvantage that in the case where image sensors are disposed near the adjacent corners of a detection area, the image sensors are physically situated outside the detection area in the lateral direction. By the use of the curved mirrors, the image sensors and the light sources can be disposed within the lateral dimension of the detection area.

### CITATION LIST

### Patent Literature

Patent Document 1: Japanese Patent Application Kokai Publication No. 2001-142630

### SUMMARY OF INVENTION

### Technical Problem

However, in the technique of Patent Document 1, the curved mirrors are still disposed near the adjacent corners of the detection area, so that there is a limitation on the installation position of the curved mirrors. Further, the arrangement positions of the curved mirrors, the image sensor, and the light sources need to be determined accurately, and it is difficult to install these components individually in an optional manner. Further, when the position detection apparatus is applied to a board surface of a blackboard or whiteboard to construct a digitizer, it is difficult to install such curved mirrors that can cover an enormously large detection area. Further, it can be considered that the pair of curved mirrors and pair of image sensors are integrated into a unit for fixation of the relative position between them so as to facilitate their positioning. In this case, however, the unit size is correspondingly increased so that the unit covers the entire side of the detection area. Thus, in the case where the detection area is enormously large, the size of the entire apparatus is increased.

Further, in Patent Document 1, a half mirror, etc., is used to make the optical axes of the light source and image sensor coincide with each other, so that the amount of light attenuates, resulting in low efficiency. Further, it is difficult to make the optical axes of the respective components, including the curved mirrors, coincide with one another.

Further, an optical position detection apparatus is designed to calculate a pointing position by detecting shadow created when light parallel to the surface of the detection area is blocked out or detecting reflection light. Therefore, a case may occur where a touch of a pointer on the detection area cannot be detected if the light parallel to the surface of the detection area and the viewing field of a camera do not exist close to the detection area. That is, there has been a case where the light is blocked out to cause erroneous touch detection although a pointer is not actually in contact with the detection surface. However, in the case of a large detection area equivalent to a board surface of a blackboard or whiteboard, when the light parallel to the surface of the detection area or the viewing field of a camera is brought too close to the surface of the detection area, the light or the viewing field is blocked out by warpage or irregularity of the board surface, which may disable detection of a pointing position. Thus, there is a need for separating the light from the surface of the detection area in a certain distance, thereby impeding the accurate touch detection.

In view of the above situation, an object of the present invention is to provide an optical position detection apparatus having a compact detection unit and capable of being easily detached and attached and further to provide an optical position detection apparatus enabling accurate touch detection.

### Means for Solving the Problems

To achieve the above object of the present invention, according to the present invention, there is provided an optical position detection apparatus comprising: a retroreflective member that is provided in the pointer or disposed so as to cover two predetermined sides of a perimeter of a detection area; and a detection unit that is disposed adjacent to a corner opposite to the two predetermined sides of the perimeter of the detection area and detects a pointing position of the pointer by using reflection light reflected from the retroreflective member, the detection unit including at least two detection sections each having a light source section that emits light traveling along the surface direction of the detection area and a camera section that images reflection light emitted from the light source section and reflected by the retroreflective member, wherein the light source section has an irradiation angle wide enough to irradiate the two predetermined sides of the perimeter of the detection area with light, and the camera section is disposed close to the light source section and has a viewing angle wide enough to image the two predetermined sides of the perimeter of the detection area.

The detection unit may be detachably attached adjacent to the corner opposite to the two predetermined sides of the perimeter of the detection area.

The retroreflective member that is disposed so as to cover the two predetermined sides of the perimeter of the detection area is detachably attached adjacent to the two predetermined sides of the perimeter of the detection area.

The detection unit and/or the retroreflective member may have a magnet for detachable attachment to a periphery of the detection area.

The optical position detection apparatus may further include, in the periphery of the detection area, a positioning base member made of a ferromagnetic material to which the magnet provided in the detection unit and/or the retroreflective member can be adhered.

According to the present invention, there is also provided an optical position detection apparatus capable of detecting a pointing position of a pointer to be input to a detection area having substantially a rectangular shape, the apparatus comprising: a pointer having, at its tip portion, a light source; and a detection unit that is disposed adjacent to a corner opposite to two predetermined sides of a perimeter of the detection area and detects a pointing position of the pointer by using light emitted from the light source of the pointer, the unit including at least two camera sections that image light emitted from the light source of the pointer, wherein each of the camera sections has a viewing angle wide enough to image the two predetermined sides of the perimeter of the detection area.

According to the present invention, there is further provided an optical position detection apparatus capable of detecting a pointing position of a pointer to be input to a detection area having substantially a rectangular shape, the apparatus comprising: a detection unit that is disposed adjacent to a corner opposite to two predetermined sides of a perimeter of the detection area and detects a pointing position of the pointer, the unit including a light source section that emits light traveling along the surface direction of the detection area and at least two camera sections that image reflection light emitted from the light source section and reflected by the pointer, wherein each of the camera sections has a viewing angle wide enough to image the two predetermined sides of the perimeter of the detection area, and the light source section is disposed between the at least two camera sections and has an irradiation angle wide enough to irradiate the two predetermined sides of the perimeter of the detection area.

Each of the camera sections is disposed such that an angle of the imaging surface of the camera section is about 45 degrees to the two predetermined sides of the perimeter of the detection area.

Each of the camera sections may have an area image sensor, the detection unit may detect also a specular image of the pointer specularly reflected on the detection area and detect a touch of the pointer onto the detection area based on a distance between the image of the pointer and the specular image of the pointer.

Based on the distance between the pointing position of the pointer to be detected and two camera sections, the detection unit may detect the specular image of the pointer by using a camera section more remote from the pointer than the other.

Each of the camera sections may only need to have a viewing angle wide enough to image the entire surface of the detection area.

### Advantageous Effects of Invention

The optical position detection apparatus of the present invention has advantages that the detection unit is configured in a compact shape, detaching and attaching of the optical position detection apparatus can easily be performed, and touch detection can be performed accurately.

### BRIEF DESCRIPTION OF DRAWINGS

FIG. 1 is a schematic configuration view for explaining an optical position detection apparatus according to a first embodiment of the present invention.

FIG. 2 is a schematic side view for explaining a configuration of a detection section of a detection unit of the optical position detection apparatus according to the first embodiment of the present invention.

FIG. 3 is a schematic configuration view for explaining an optical position detection apparatus according to a second embodiment of the present invention.

FIG. 4 is a schematic configuration view for explaining an optical position detection apparatus according to a third embodiment of the present invention.

FIG. 5 is a schematic configuration view for explaining an optical position detection apparatus according to a fourth embodiment of the present invention.

FIG. 6 is schematic views for explaining a detection unit capable of detecting a specular image in the optical position detection apparatus of the present invention.

### DESCRIPTION OF EMBODIMENTS

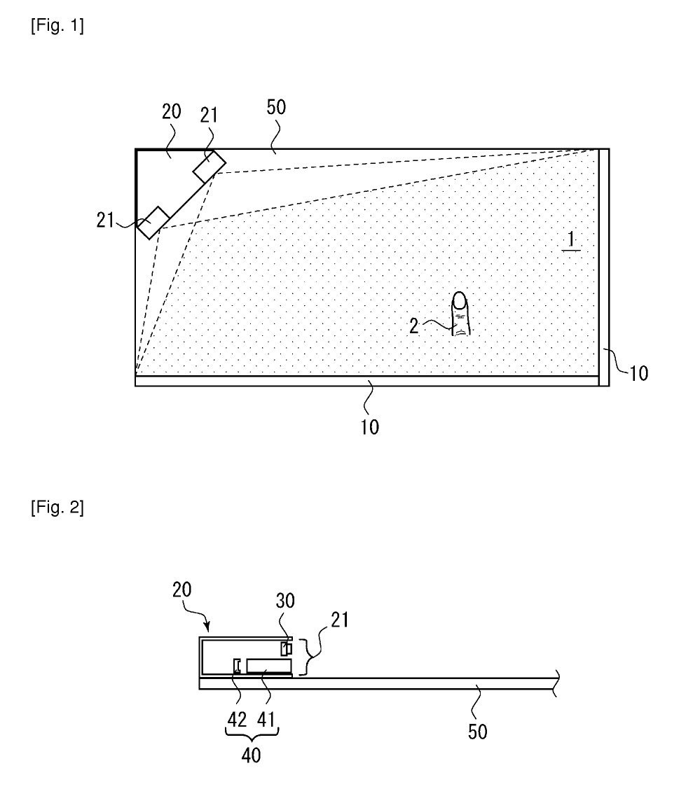

Embodiments for practicing the present invention will be described below with reference to the accompanying drawings. FIG. 1 is a schematic configuration view for explaining an optical position detection apparatus according to a first embodiment of the present invention. The first embodiment is an example in which a position pointed by a pointer, such as a finger or a pointing bar, that itself does not have a special function is detected. As shown in FIG. 1, the optical position detection apparatus that can detect a pointing position of a pointer 2 on a detection area 1 is mainly constituted by a retroreflective member 10 and a detection unit 20. The detection area 1 has substantially a rectangular shape and corresponds to a portion in which the viewing fields of detection sections 21, 21 of the detection unit 20 overlap each other as described later.

The retroreflective member 10 is disposed so as to cover two predetermined sides of a perimeter of the substantially rectangular detection area 1. More specifically, the retroreflective member 10 is disposed so as to cover the right and bottom sides of the detection area 1 in the example shown in FIG. 1.

The detection unit 20 is disposed adjacent to a corner opposite to the two predetermined sides of the perimeter of the detection area. More specifically, the detection unit 20 is disposed adjacent to a corner opposite to the two sides on which the retroreflective member is disposed. In the example of FIG. 1, the detection unit 20 is disposed near the upper left corner. The detection unit 20 detects a pointing position of the pointer 2 by using reflection light from the retroreflective member 10. The detection unit 20 shown in FIG. 1 includes two detection sections 21.

FIG. 2 is a schematic side view for explaining a configuration of the detection section of the detection unit of the optical position detection apparatus according to the first embodiment of the present invention. In FIG. 2, the same reference numerals as those in FIG. 1 denote the same parts as those in FIG. 1. As shown in FIG. 2, the detection section 21 mainly includes a light source section 30 and a camera section 40.

The light source section 30 emits light in the surface direction of the detection area 1. The light source section 30 has such an irradiation angle that the two predetermined sides of the perimeter of the detection area 1 can be irradiated with light. That is, the light source section 30 is configured to have an irradiation angle that covers the right and bottom sides of the detection area 1 on which the retroreflective member 10 is disposed. The light source section 30 may have a structure obtained by arranging, e.g., a plurality of LEDs (Light Emitting Diodes) in a fan-shape.

The camera section 40 images reflection light emitted from the light source section 30 and reflected by the retroreflective member 10 (see FIG. 1). The camera section 40 includes a wide-angle lens 41 and an image sensor 42, is disposed close to the light source section 30, and has a viewing angle wide enough to image the two predetermined sides of the perimeter of the detection area 1. That is, the camera section 40 is configured to have a viewing angle that covers the right and bottom sides of the detection area 1 on which the retroreflective member 10 is disposed. It is sufficient for the wide-angle lens 41 to have a viewing angle of 90 degrees or more, preferably, 100 degrees or more and be able to image the two sides of the perimeter of the detection area. As a matter of course, the wide-angle lens 41 has a wider viewing angle than that mentioned above. The image sensor 42 is a solid-state image sensing device such as a CCD or a CMOS. The image sensor 42 may be a linear image sensor or an area image sensor. In the case where the image sensor 42 is an area image sensor, the image sensor 42 can detect the motion of the pointer before and after touch detection by the position detection apparatus in the height detection, so that higher level detection can be achieved.

The camera section used in the optical position detection apparatus of the present invention is not limited to the example shown in the drawing but may have any configuration as long as the camera section has a viewing angle wide enough to image the two sides of the perimeter of the detection area.

The above-configured detection sections 21 are each connected to a controller or a computer (not shown) provided inside or outside the detection unit. The detection unit and the controller or the like may be connected to each other by wire using a USB (Universal Serial Bus) or by radio using Bluetooth (Registered Trademark).

The detection unit 20 shown in FIG. 1 has a triangular shape. This is because of easy positioning to the corner of a board surface 50 of a blackboard or whiteboard. For example, in the case where the optical position detection apparatus of the present invention is used with the board surface 50 of a blackboard or whiteboard as a digitizer, the detection unit is detachably attached to a portion adjacent to a corner opposite to the two predetermined sides of the perimeter of the detection area. That is, the detection unit is attached to the corner of the board surface 50 of a blackboard, etc. as shown in FIG. 1. Similarly, the retroreflective member 10 may be detachably attached to the portion adjacent to the two predetermined sides of the perimeter of the detection area. That is, as shown in FIG. 1, the retroreflective member is attached to the right and bottom sides of the board surface 50 of the blackboard, etc. The detection unit and the retroreflective member may each have a magnet on the rear surface serving as the attaching surface for detachment/attachment to/from the periphery of the detection area. The use of the magnet makes it easy to attach the detection unit and the retroreflective member to the board surface 50 of the blackboard or whiteboard.

More specifically, a commercially available whiteboard having a size of 160 cm×120 cm is prepared, and the detection unit having the camera sections which are disposed apart from each other by about 20 cm is attached to the upper left corner of the board surface of this whiteboard using a magnet. In the case where the detection unit has a triangular shape, the positioning can easily be made.

The camera section may be disposed such that an angle of the imaging surface of the camera section is about 45 degrees to the two predetermined sides of the perimeter of the detection area. For example, two camera sections each having a viewing angle of 90 degrees are disposed apart from each other by about 20 cm to 30 cm on the corner of the board surface of the whiteboard. With this configuration, the viewing fields of the two camera sections face in substantially the same direction, and an area in which the viewing fields of the two camera sections overlap each other is set as the detection area.

As described later, the optical position detection apparatus of the present invention is configured to detect a pointing position of the pointer using the principle of triangulation, so that the distance between the two detection sections 21 influences the detection accuracy, and the smaller the distance between the two detection sections 21, the worse the detection accuracy. Therefore, by reducing the distance between the two detection sections 21 while maintaining the detection accuracy at an acceptable level, the size of the detection unit 20 can be reduced. In the optical position detection apparatus of the present invention, an area in which the viewing fields (an imaging area of the camera section and an irradiation area of the light source section) of the detection sections 21 overlap each other is set as the detection area 1. Thus, when the detection unit 20 is disposed on the board surface 50 of a blackboard or whiteboard, the size reduction of the detection unit 20 is effective in terms of making the size of the detection area close to that of a blackboard, etc.

Further, in the case where the optical position detection apparatus of the present invention is used with a liquid crystal display device or a plasma display device as a touch panel, a positioning base member made of a ferromagnetic material to which a magnet can be adhered may be attached to the bezel of the display area using a double-faced tape. The positioning base member preferably has, e.g., a concave portion to which the magnet provided in the detection unit or the retroreflective member is fitted so as to facilitate the positioning of the detection unit or the retroreflective member. As the positioning base member, one having a frame shape like the bezel may be used. In this case, the installation position of the detection unit or the retroreflective member is previously determined, so that arrangement of the detection unit or the retroreflective member can be facilitated. Further, in place of the frame-like positioning base member, a plate-like positioning base member provided in a portion corresponding to the position of the magnet of the detection unit or the retroreflective member may be used. Also in this case, by allowing the magnet to be fit to the concave portion formed in the positioning base member, the detection unit and the retroreflective member can easily be arranged.

Calibration of a detected position in the detection area may be performed after the installation of the detection unit and the retroreflective member as an adjustment process for detection of an accurate pointing position.

Next, processing of detecting a pointing position of a pointer performed by using the above-configured optical position detection apparatus according to the first embodiment of the present invention will be described. The first embodiment of the present invention has a configuration for detecting a pointing position of a pointer, such as a finger or a pointing bar, that itself does not have a special function. In the present embodiment, light emitted from the light source section 30 of the detection section 21 is reflected by the retroreflective member 10, and the retroreflected light is imaged by the camera section 40. In the present invention, the light source section 30 has an irradiation angle wide enough to irradiate the two predetermined sides of the perimeter of the detection area with light and the camera section has a viewing angle wide enough to image the two predetermined sides of the perimeter of the detection area, so that the image of the retroreflective member 10 provided on the two sides is formed on the camera section 40 of each detection section 21. In the case where the pointer 2 such as a finger is input to the detection area 1, reflection light from the retroreflective member 10 is blocked by the pointer 2 with the result that the image corresponding to shadow is detected by each detection section 21. Based on the principle of triangulation using the position of the shadow detected by the two detection sections 21 and the distance between the two detection sections 21, the pointing position (two-dimensional coordinates) of the pointer can be calculated. This calculation may be performed by a computer provided inside or outside the detection unit 20.

Although the detection unit 20 includes two detection sections 21 in the illustrated example, the present invention is not limited to this but the detection unit 20 may include three detection sections. In this case, another detection section may be disposed between the two detection sections. This configuration reduces error. The number of the detection sections may be increased to four or more.

As described above, according to the present invention, there is provided an optical position detection apparatus having a compact detection unit and capable of being easily detached and attached.

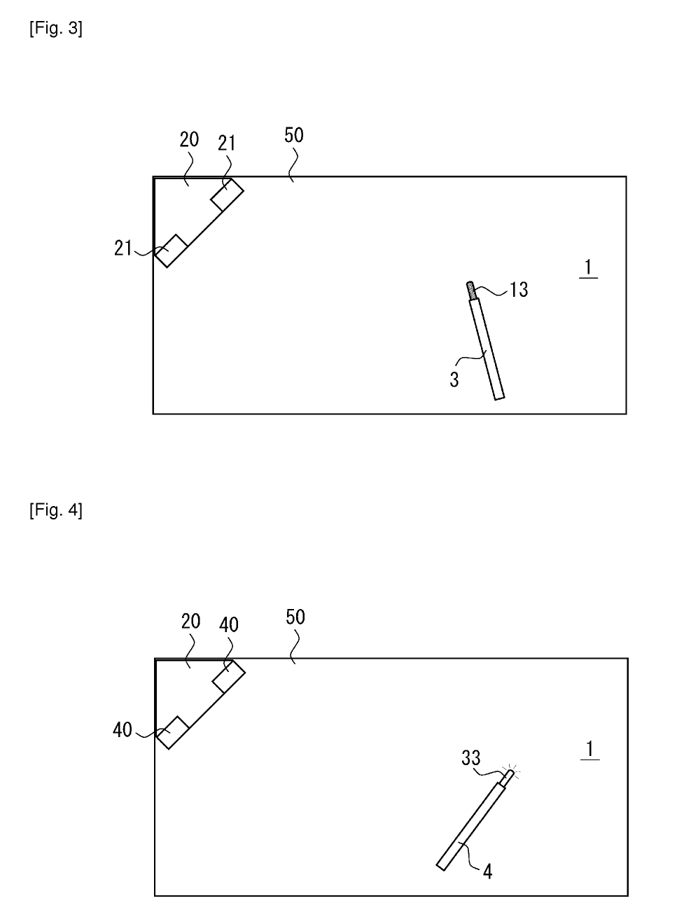

Next, an optical position detection apparatus according to a second embodiment of the present invention will be described with reference to FIG. 3. FIG. 3 is a schematic configuration view for explaining an optical position detection apparatus according to the second embodiment of the present invention. The second embodiment is a case where a pointer has a retroreflective member. In FIG. 3, the same reference numerals as those in FIG. 1 denote the same parts as those in FIG. 1. As shown in FIG. 3, a pointer 3 to be input to the detection area 1 has at its tip portion a retroreflective member 13, while the retroreflective member covering the two sides of the detection area as used in the first embodiment is not provided. Other configurations are the same as those of the first embodiment, and the descriptions thereof will be omitted.

Processing of detecting a pointing position of a pointer performed by using the above-configured optical position detection apparatus according to the second embodiment will be described. In the case where the pointer 3 is not input to the detection area 1, nothing is detected by the camera section 40 of the detection section 21. When the pointer 3 is input to the detection area 1, light emitted from the light source section 30 of the detection section 21 is reflected by the retroreflective member 13 provided at the tip portion of the pointer 3, and the retroreflected light is imaged by the camera section 40. Thus, based on the principle of triangulation using the positions of the reflection lights detected by the two detection sections 21 and the distance between the two detection sections 21, the pointing position (two-dimensional coordinates) of the pointer can be calculated.

Since there is provided no frame member, such as the retroreflective member, that surrounds the detection area in the optical position detection apparatus of the second embodiment, the detection area need not be formed in a rectangular shape equivalent to the board surface as the illustrated example, but an area having a distance over which the detection sections can detect the pointer and in which the viewing fields of the detection sections overlap each other may be set as the detection area.

Further, in the case where ambient light and reflection light are indistinguishable from each other in the optical position detection apparatus, there is a possibility that the pointer is falsely recognized due to absence of the frame member of the perimeter of the detection area. To prevent this, e.g., non-reflective frame member is used to surround the periphery of the detection area so as to block the ambient light. Alternatively, a configuration may be adopted in which the light source section is made to emit pulse light, and filtering is performed so as to detect only the reflection light corresponding to the pulse light. Further alternatively, a configuration may be adopted in which infrared LED are used as the LEDs of the light source section, an infrared transmission filter is provided in the camera section, and imaging operation is performed only during emission of light from the light source section.

Other configurations, applications and effects are the same as those of the first embodiment, and the descriptions thereof will be omitted.

Next, an optical position detection apparatus according to a third embodiment of the present invention will be described with reference to FIG. 4. FIG. 4 is a schematic configuration view for explaining an optical position detection apparatus according to the third embodiment of the present invention. The third embodiment is a case where a pointer has a light source. In FIG. 4, the same reference numerals as those in FIGS. 1 and 2 denote the same parts as those in FIGS. 1 and 2. As shown in FIG. 4, a pointer 4 to be input to the detection area 1 has at its tip portion a light source 33 such as an LED, while the retroreflective member covering the two sides of the perimeter of the detection area as used in the first embodiment, or the retroreflective member at the tip portion of the pointer as used in the second embodiment, is not provided.

Further, the detection unit 20 has at least two camera sections 40 that image light emitted from the light source section 33 of the pointer 4. That is, the detection unit 20 has the camera section and the light source section in the first and second embodiments, while in the third embodiment, only the camera section 40 is provided in the detection unit 20. The camera section 40 has a viewing angle wide enough to image two predetermined sides of the perimeter of the detection area 1. The two predetermined sides are, e.g., right and bottom sides in the illustrated example.

Processing of detecting a pointing position of a pointer performed by using the above-configured optical position detection apparatus according to the third embodiment will be described. In the case where the pointer 4 is not input to the detection area 1, nothing is imaged by the camera section 40 of the detection unit 20. When the pointer 4 is input to the detection area 1, light emitted from the light source section 33 provided at the tip portion of the pointer 4 is imaged by each camera section 40. Thus, based on the principle of triangulation using the positions of the light detected by the two camera sections 40 and the distance between the two camera sections 40, the pointing position (two-dimensional coordinates) of the pointer can be calculated.

There is provided no frame member that surrounds the detection area also in the optical position detection apparatus of the third embodiment, so that in the case where ambient light and reflection light are indistinguishable from each other, there is a possibility that the pointer is falsely recognized. To prevent this, e.g., non-reflective wall member may be used to surround the periphery of the detection area. Alternatively, a configuration may be adopted in which the light source provided at the tip portion of the pointer is made to emit pulse light, and filtering is performed so as to detect only light corresponding to the pulse light. Further alternatively, a configuration may be adopted in which infrared LED is used as the LED provided at the tip portion of the pointer, an infrared transmission filter is provided in the camera section, and imaging operation is performed only during emission of light from the infrared LED.

Other configurations, applications and effects are the same as those of the first and second embodiments, and the descriptions thereof will be omitted.

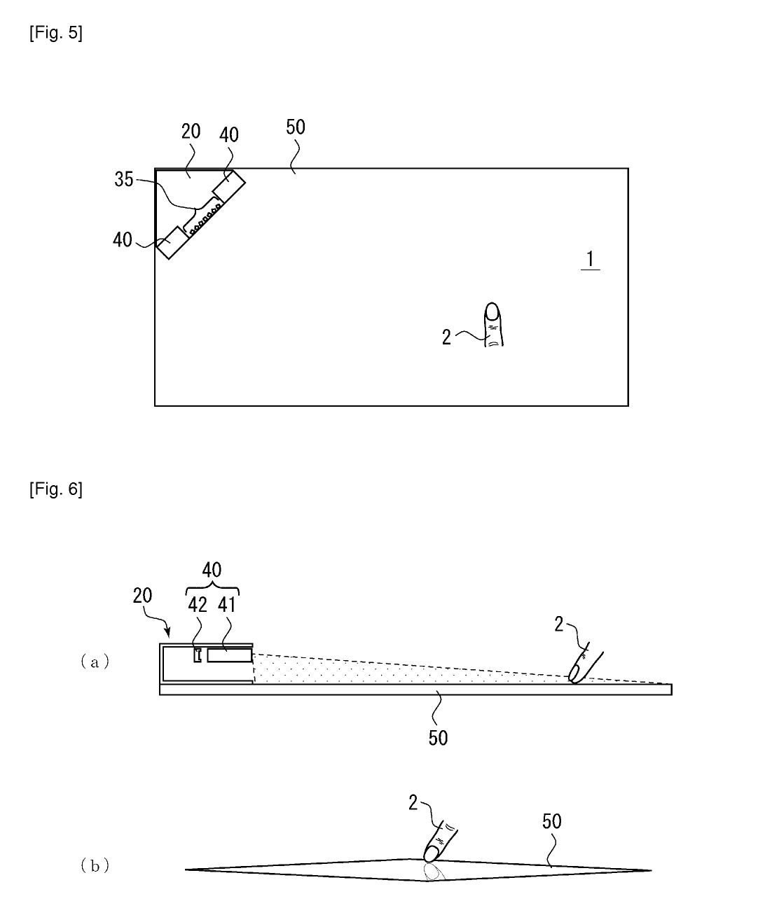

Next, an optical position detection apparatus according to a fourth embodiment of the present invention will be described with reference to FIG. 5. FIG. 5 is a schematic configuration view for explaining an optical position detection apparatus according to the fourth embodiment of the present invention. The fourth embodiment is a case where the image of a pointer, such as a finger or a pointing bar, that itself does not have a special function is directly imaged to detect a position pointed by the pointer. In FIG. 5, the same reference numerals as those in FIG. 4 denote the same parts as those in FIG. 4.

As shown in FIG. 5, the pointer 2 is a finger or the like. The detection unit 20 has at least two camera sections 40. A light source section 35 is disposed between the two camera sections and is configured to have an irradiation angle wide enough to irradiate the two predetermined sides of the perimeter of the detection area 1 with light. The light source section 35 is constituted by, e.g., a plurality of infrared LEDs which are arranged so as to spread in a radial fashion. The light source section 35 may have a configuration in which the plurality of infrared LEDs each inclined at predetermined angles so as to allow the light from the LEDs to spread radially are linearly arranged as shown in FIG. 5 or in which the plurality of infrared LEDs are arranged in a fan-shape. Further, a diffuser plate may be disposed in front of the LEDs so as to make the light from the LEDs uniform. For example, a lenticular lens may be used as the diffuser plate in order to broadly irradiate the detection area in the surface direction with smooth light.

Further, in the optical position detection apparatus of the fourth embodiment, the camera section directly images the image of the pointer, so that, for example, a configuration may be adopted in which the light source section 35 is made to emit strong light at extremely short time intervals, and imaging operation is performed during the emission. The emission amount of the light source section may be determined based on the shutter speed and the aperture of the camera section and a standard luminance of the detection area. A configuration may be adopted in which a plurality of infrared LEDs are used as the LEDs of the light source section, an infrared transmission filter is provided in front of the lens of the camera section or in front of the image sensor, and imaging operation is performed only during emission of infrared ray light from the light source section. In this case, it is possible to reduce influence of ambient light.

Processing of detecting a pointing position of a pointer performed by using the above-configured optical position detection apparatus according to the fourth embodiment will be described. In the case where the pointer 2 is not input to the detection area 1, nothing is imaged by the camera section 40 of the detection unit 20. When the pointer 2 is input to the detection area 1, the pointer 2 is irradiated with light emitted from the light source section 35, and the image of the pointer 2 is imaged by each camera section 40 as reflection light. Thus, based on the principle of triangulation using the positions of the images of the pointers 2 detected by the two camera sections 40 and the distance between the two camera sections 40, the pointing position (two-dimensional coordinates) of the pointer can be calculated.

Other configurations, applications and effects are the same as those of the first to third embodiments, and the descriptions thereof will be omitted.

In the above embodiments, the image sensor of the camera section may be a linear image sensor or an area image sensor. In the case where an area image sensor is used, it is possible to achieve touch detection of the pointer by detecting also a specular image of the pointer specular-reflected on the surface of the detection area. This will be described more in detail with reference to FIG. 6.

FIG. 6 is a schematic view for explaining a detection unit capable of detecting the specular image in the optical position detection apparatus of the present invention. FIG. 6(a) is a side view of the optical position detection apparatus, and FIG. 6(b) is a schematic view for explaining a pointer image as viewed from the detection unit. In FIG. 6, the same reference numerals as those in FIGS. 1 to 5 denote the same parts as those in FIGS. 1 to 5. For convenience of explanation, in FIG. 6(b), not the actual range of the viewing field of the detection unit but a wider area is shown.

The camera section 40 uses an area image sensor as the image sensor 42. The detection unit is configured to detect also the specular image of the pointer specular-reflected on the detection area and detects a touch of the pointer onto the detection area 1 based on a distance between the image of the pointer 2 and specular image of the pointer 2.

As shown in FIG. 6(b), when viewed from the detection unit, the specular image of the pointer 2 is formed on the surface of the detection area, i.e., board surface 50 of a whiteboard, etc. When the pointer 2 is fully touched on the surface of the detection area 1, the image of the pointer 2 and specular image thereof are integrated with each other, and the distance between the images becomes 0. However, a clearance exists between the image of the pointer 2 and specular image thereof before the touch. Thus, based on the distance between the image of the pointer 2 and specular image thereof, whether or not the pointer 2 has been touched on the detection surface can be detected. It is preferable to use a board surface having high reflection efficiency, such as a whiteboard, a plasma display screen, an LCD screen having a glass or acrylic front surface, or the like.

The camera section only needs to have a viewing angle wide enough to image the two predetermined sides of the perimeter of the detection area in terms of the planar direction and a viewing angle wide enough to image a range from the two predetermined sides of the perimeter of the detection area adjacent to and immediately below the camera section in terms of the vertical direction as shown in FIG. 6(a). That is, the camera section only needs to have a viewing angle wide enough to image the entire surface of the detection area 1. The camera section is disposed at a certain height from the board surface 50 so as to be able to image the entire surface of the detection area 1 at a downward angle.

In conventional optical position detection apparatuses, touch detection is performed under a condition that light from a light source or viewing field of the camera section is made parallel to and made as close as possible to the surface of the detection area. However, as described above in the problems of the prior art, when the light parallel to the surface of the detection area is made too close to the surface of the detection area, the light or the viewing field is blocked out by warpage or irregularity of the board surface, which may disable detection of a pointing position. However, in the present invention, the camera section is disposed at a certain height from the surface of the detection area as shown in FIG. 6(b) and has a viewing angle wide enough to image the entire surface of the detection area, preventing the light or viewing field from being blocked out by the warpage or irregularity of the board surface.

The smaller the incident angle of the viewing field of the camera section with respect to the board surface, that is, the closer the viewing field is to the board surface in the vertical direction, the lower the reflectivity of the specular image of the pointer becomes, and the fainter the specular image (the more difficult it is to detect the specular image). On the other hand, the larger the incident angle of the specular image with respect to the board surface, that is, the closer the viewing field is in a parallel orientation with respect to the board surface, the higher the reflectivity of the specular image of the pointer becomes, and the stronger the specular image (the easier it is to detect the specular image). Therefore, it is preferable for the detection unit to perform control such that a camera section more remote from the pointer than the other is used for detection of the specular image of the pointer. In the case where a configuration is adopted in which the touch detection is made after the detection of the pointing position of the pointer, the positional relationship between the respective camera sections and the pointer can be grasped, so that it is possible to achieve the touch detection by using the remote camera section by the specular image. Further, the touch detection may be made by using a camera section that receives a stronger specular image. With regard to the touch detection, the detection unit need not be provided adjacent to one corner of the detection area but the camera sections may be provided in the vicinities of the left and right corners of the detection area, respectively.

The optical position detection apparatus according to the first embodiment of the present invention can detect reflection light from the retroreflective member and specular image of shadow of the pointer, so that the touch detection can be achieved. Further, in the second and third embodiments, the touch detection can be achieved since the specular image of the pen tip can be detected.

The optical position detection apparatus of the present invention is not limited to the above illustrated examples but may variously be modified within the scope of the present invention.

### EXPLANATION OF REFERENCE SYMBOLS

1: Detection area
2, 3, 4: Pointer
10, 13: Retroreflective member
20: Detection unit
21: Detection section
30, 33, 35: Light source section
40: Camera section
41: Wide-angle lens
42: Image sensor
50: Board surface

1. An optical position detection apparatus capable of detecting a pointing position of a pointer to be input to a detection area having substantially a rectangular shape, the apparatus comprising:
a retroreflective member that is provided in the pointer or disposed so as to cover two predetermined sides of a perimeter of the detection area; and
a detection unit that is disposed adjacent to a corner opposite to the two predetermined sides of the perimeter of the detection area and detects a pointing position of the pointer by using reflection light reflected from the retroreflective member, the unit including at least two detection sections each having a light source section that emits light traveling along the surface direction of the detection area and a camera section that images reflection light emitted from the light source section and reflected by the retroreflective member,
the light source section having an irradiation angle wide enough to irradiate the two predetermined sides of the perimeter of the detection area with light, and
the camera section being disposed close to the light source section and having a viewing angle wide enough to image the two predetermined sides of the perimeter of the detection area.

2. The optical position detection apparatus according to claim 1, in which the detection unit is detachably attached adjacent to the corner opposite to the two predetermined sides of the perimeter of the detection area.

3. The optical position detection apparatus according to claim 1, in which the retroreflective member that is disposed so as to cover the two predetermined sides of the perimeter of the detection area is detachably attached adjacent to the two predetermined sides of the perimeter of the detection area.

4. The optical position detection apparatus according to claim 2, in which the detection unit and/or the retroreflective member have a magnet for detachable attachment to a periphery of the detection area.

5. The optical position detection apparatus according to claim 4, further comprising, in the periphery of the detection area, a positioning base member made of a ferromagnetic material to which the magnet provided in the detection unit and/or the retroreflective member can be adhered.

6. An optical position detection apparatus capable of detecting a pointing position of a pointer to be input to a detection area having substantially a rectangular shape, the apparatus comprising:
a pointer having, at its tip portion, a light source; and
a detection unit that is disposed adjacent to a corner opposite to two predetermined sides of a perimeter of the detection area and detects a pointing position of the pointer by using light emitted from the light source of the pointer, the unit including at least two camera sections that image light emitted from the light source of the pointer,
each of the camera sections having a viewing angle wide enough to image the two predetermined sides of the perimeter of the detection area.

7. An optical position detection apparatus capable of detecting a pointing position of a pointer to be input to a detection area having substantially a rectangular shape, the apparatus comprising:
a detection unit that is disposed adjacent to a corner opposite to two predetermined sides of a perimeter of the detection area and detects a pointing position of the pointer, the unit including a light source section that emits light traveling along the surface direction of the detection area and at least two camera sections that image reflection light emitted from the light source section and reflected by the pointer,
each of the camera sections having a viewing angle wide enough to image the two predetermined sides of the perimeter of the detection area, and
the light source section being disposed between the at least two camera sections and having an irradiation angle wide enough to irradiate the two predetermined sides of the perimeter of the detection area.

8. The optical position detection apparatus according to claim 1, in which each of the camera sections is disposed such that an angle of the imaging surface of the camera section is about 45 degrees to the two predetermined sides of the perimeter of the detection area.

9. The optical position detection apparatus according to claim 1, in which each of the camera sections has an area image sensor, and the detection unit detects also a specular image of the pointer specularly reflected on the detection area and detects a touch of the pointer onto the detection area based on a distance between the image of the pointer and the specular image of the pointer.

10. The optical position detection apparatus according to claim 9, in which, based on the distance between the pointing position of the pointer to be detected and two camera sections, the detection unit detects the specular image of the pointer by using a camera section more remote from the pointer than the other.

11. The optical position detection apparatus according to claim 9, in which each of the camera sections has a viewing angle wide enough to image the entire surface of the detection area.

12. The optical position detection apparatus according to claim 6, in which each of the camera sections is disposed such that an angle of the imaging surface of the camera section is about 45 degrees to the two predetermined sides of the perimeter of the detection area.

13. The optical position detection apparatus according to claim 7, in which each of the camera sections is disposed such that an angle of the imaging surface of the camera section is about 45 degrees to the two predetermined sides of the perimeter of the detection area.

14. The optical position detection apparatus according to claim 6, in which each of the camera sections has an area image sensor, and the detection unit detects also a specular image of the pointer specularly reflected on the detection area and detects a touch of the pointer onto the detection area based on a distance between the image of the pointer and the specular image of the pointer.

15. The optical position detection apparatus according to claim 7, in which each of the camera sections has an area image sensor, and the detection unit detects also a specular image of the pointer specularly reflected on the detection area and detects a touch of the pointer onto the detection area based on a distance between the image of the pointer and the specular image of the pointer.
